(19) United States
(12) Patent Application Publication
(10) Pub. No.: US 2006/0145041 A1
(43) Pub. Date: Jul. 6, 2006

(54) Conformingly pliable bottle display holder

(76) Inventors: Charles Maxwell Wagenknecht, Rockford, IL (US); Samuel James Wagenknecht, Rockford, IL (US); Terry Lee Wagenknecht, Rockford, IL (US)

Correspondence Address: TERRY LEE WAGENKNECHT, 6693 HEATHER LANE, ROCKFORD, IL, 61114, US

(21) Appl. No.: 11/028,137

(22) Filed: Jan. 3, 2005

(51) Int. Cl. A61J 9/06

(52) U.S. Cl. 248/312

(57) ABSTRACT

A bottle display holder for retaining a plastic bottle to another object, comprising an elongate, planar, conformingly pliable plastic material, an area surrounding 36 a cap stop rim primary gripping aperture 20, and means for securing a loop shape 44 for pocket or placket retention. One straight line edge 21 of said primary aperture 20 wedges between a bottle's cap stop rim 50 and a tamper-proof retaining band 49. A wedge-locked aperture surrounding area 36 is distorted into a position of multi-curvatures and axially different bends to further strengthen its cap stop rim gripping ability. A holder also comprises a plurality of means of attachment for forming a springably expansive looped shape 44 which retains a holder and held bottle to other objects in multiple ways. Comprisements cooperate to transform a previously pliable material into a more rigid bottle retaining form.

### CROSS-REFERENCE TO RELATED APPLICATIONS

| | | | |
|---|---|---|---|
| 5,183,169 | 2/1993 | Grzych | 215/100 |
| 5,695,232 | 12/1997 | Tipp | 294/87.2 |
| 5,882,057 | 3/1999 | Fahy | 294/159 |
| 5,938,256 | 8/1999 | Lovette | 294/87.2 |
| 5,960,973 | 10/1999 | Markson | 215/386 |
| 6,019,335 | 2/2000 | Schati | 248/312 |
| 6,056,115 | 5/2000 | Olsen | 206/150 |
| 6,131,779 | 8/1997 | Gendala | 224/148.1 |
| 6,273,283 B1 | 8/2001 | Terrana | 215/383 |
| 6,279,794 B1 | 8/2001 | Miyazaki | 224/148.7 |
| 6,283,346 | 9/2001 | Thomas | 224/14.6 |
| 6,334,531 | 1/2002 | Valkovich | 206/163 |
| 6,352,235 B2 | 3/2002 | Cizek | 248/692 |
| 6,394,329 B1 | 5/2002 | Magee | 224/678 |
| 6,394,517 | 5/2002 | Borg | 294/31.2 |
| 6,401,993 | 6/2002 | Andrino | 224/148.5 |
| 6,443,338 | 9/2002 | Giaconna | 224/148.6 |
| 6,533,148 B1 | 3/2003 | Dahl | 224/148.6 |
| 6,626,333 B2 | 9/2003 | Levesque et al | 224/148.6 |
| 6,695,371 B1 | 2/2004 | Simkins | 294/33 |

### STATEMENT REGARDING FEDERALLY SPONSORED RESEARCH OR DEVELOPMENT

Not applicable.

### REFERENCE TO SEQUENCE LISTING

Not applicable.

### BACKGROUND

1. Field of Invention

This invention relates to bottle holders for retaining a plastic bottle to an object, and of a bottle's type where a bottle's cap breaks away from a tamper proof retaining band, and where said band is located just vertically above a bottle's cap stop rim.

2. Description of Prior Art

Previous items used to attach a plastic bottle of liquid to a person's clothing or other objects, were formed from various hard plastics, metals, or ropes. P Most were bulky in size or shape, and difficult to carry conveniently in a pocket. A user could not forget a holder's shape, and place it in their back pocket, where protruding parts could pierce clothing or skin.

Most versions of a beverage bottle holding device would include specialized parts, moving parts, or detachable parts, including metal ferrules, nylon or rope strings, hinged parts, or rigid and protruding plastic gripping assemblies.

Most were designed on the assumption that a re-useable bottle holder had to be made from a rigid material, an overly complicated design, or overly simplified rope-like grippature for gripping a bottle's cap stop rim.

(a) Rigid designs are protrudingly obtrusive for storage on a person's body.

(b) Overly complicated designs require assembly in manufacturing.

(c) Overly simple rope designs require small ferrules or dangerous parts.

Most were made for one method of attachment to a person's clothing or object.

Size and shapes of most previous versions prohibited cost effective packaging with a product meant to be held.

Most versions which did consider advertising indicia space, did not consider a user's option of printing their own indicia via computer printed decals.

None were found that considered displaying a held product against an interior glass window of a refrigerated display case at a prime location of purchase decision.

None were found to be conformingly pliable to accomodate machine vendability with a bottle that is to be held.

A reuseable one piece conformingly pliable bottle holder which folds compactly in a space as small as a person's wallet compartment was not found at all.

Perimeter edge alterations to enhance indicia images at a time of manufacturing were not found at all.

A bottle's more vertically held position for a glass surface display was not found.

None were found that used a wedge-locked position of an aperture to transform a portion of a previously pliable substrate into a more rigid and bottle retaining form.

None were found using a springably expansive loop shape to transform a portion of a previously pliable substrate into a more rigid and bottle retaining form.

### SUMMARY

A conformingly pliable bottle display holder, comprising a single flat elongate pliable polymer plastic body, a wedge-locked multi curvature area surrounding a primary gripping aperture near one elongate end, and a means for fastening a springably expansive loop shape form; wherein the improvement is a conformingly pliable holder which transforms into a more rigid and bottle retaining form.

### OBJECTS AND ADVANTAGES

This invention of a conformingly pliable bottle display holder is formed from a conformingly pliable and generally planar polymer plastic substrate.

Accordingly, besides any objects and advantages previously described, more objects and advantages of this present invention are;

(a) To provide a holder (FIG. 13) which can be folded, or placed in a wallet or back pocket and sat on, with no sharp protruding parts to snag clothing or skin.

(b) To provide a holder (FIG. 1) with a uni-body, one piece structure having no extra parts to manufacture or assemble.

(c) To provide a holder (FIG. 1) where safety is a key factor in it's shape and size, and having no separate parts that can stab a user or be physically swallowed.

(d) To provide a holder (FIG. 11) where a portion remains held in a user's pocket when holding a bottle during activities of jogging, running, jumping, etc.

(e) To provide a holder (FIG. 10) which provides area for personal indica display.

(f) To provide a holder (FIG. 17) with an option of adding a window suction cup to display a held product from a merchandising user's glass display surface.

(g) To provide an applied holder (FIG. 2,3) which remains below a bottle's height for packaging within a shrink wrapped multi-pack of product it is intended to hold.

(h) To provide an applied holder (FIG. 12) which conforms to a bottle's exterior surface before a forming of a loop; wherein a holder's tabulated end is ready for securement to a bottle; whereby a product and holder are machine vendable.

(i) To provide a holder (FIGS. 3,6) where an area surrounding it's pliable substrate's gripping aperture is wedge-locked into a distortion of multi-curvatures and merging bends to transform said pliable substrate into a more rigid and bottle retaining form.

(j) To provide a holder (FIG. 4) with perimeter indented areas to aid in a formation of springably expansive loop form for retension within a user's pocket or placket.

(k) To provide a holder (FIG. 10) where a perimeter edge surrounding said indicia display area is, prior to manufacturing, alterable in shape to accommodate most advertising logo shapes without affecting any functioning of said holder.

(l) To provide a holder (FIGS. 16,17) which holds a bottle in an a more vertical and upright position by distancing a bending location from a bottle cap's sidewall.

(m) To provide a holder (FIG. 11) which mostly disappears from view when in use, such as when retained in a user's pocket, clothing placket, or waistband of pants.

### BRIEF DESCRIPTION OF THE DRAWINGS

In the drawings, closely related figures have the same number, but different alphabetic suffixes.

FIG. 1 is a front view of a preferred embodiment before forming a loop shape.

FIG. 2 is a side view after a loop is formed, and after application to a bottle, and before engagement of a primary aperture's straight line edge wedging between a bottle cap's tamper proof retaining band and a bottle's cap stop rim.

FIG. 3 is a side view after a loop is formed, and after application to a bottle, and after engagement of said straight line edge wedging, and where said loop is bendingly isolated from a primary aperture surrounding area by a holder's first perimeter indentation area.

FIG. 4 is a side view of a fully applied, wedged, multi-curvature and more rigid holder showing an approximately horizontal standoff area between a bottle cap's sidewall and a vertically downward directed looped bend.

FIG. 5 is a side view of a fully applied and wedged holder showing an approximately horizontal standoff area and a vertically upward directed looped bend.

FIG. 6 is a front view of a fully applied and wedged holder with a loop in its normal and approximately horizontal standoff position.

FIG. 7 is a rear view of a fully applied and wedged holder with a loop in its normal and approximately horizontal standoff position.

FIG. 8 is a rear view of a fully applied and wedged holder, a vertically positioned loop, and an optional window suction cup before placing in a tab receiving aperture.

FIG. 9 is and overhead view of an applied holder prior to a wedged positioning, with a loop in a vertical position, and showing snugly tight fit of primary aperture.

FIG. 10 is a front view of an applied holder before said wedged position, with a perimeter of indicia area cut in a special logo or indicia accommodating shape.

FIG. 11 is a front view of a pants pocket held bottle with indicia area hidden from view, and prior to said wedged position, and while under a light weight load.

FIG. 12 is a side view of an applied holder prior to forming a loop, and prior to a wedged positioning, and ready for temporary shrink wrap or banding of a holder's tabulated end, to temporarily fasten a holder for machine vending.

FIG. 13 is a perspective view of compact storage within a wallet compartment.

FIG. 14 is a front view showing conformability of material surrounding a holder's primary gripping aperture upon it's application to and over a bottle's cap.

FIG. 15 is a front view showing conformability of material surrounding a holder's primary gripping aperture upon it's removal from a bottle and it's cap.

FIG. 16 is a side view of an applied holder and bottle using a suction cup to hang from a vertical and flat surface, and prior to a wedged position, and without a horizontal standoff area, and showing said bottle being askew to said flat surface.

FIG. 17 is a side view of an applied holder and bottle using a suction cup to hang from a vertical flat surface using a straight line edge for said wedging process, and showing a more vertically upright position due to said horizontal standoff area.

FIG. 18,a is a front view of an alternative embodiment showing an hourglass shaped aperture with a notched area for use as an alternative tab receiving aperture, and with said straight line edge remaining perpendicular to a holder's elongate direction.

FIG. 18,b is a front view of an alternative embodiment showing the preferred embodiment's primary aperture connected to a tab receiving aperture via a slit, and with said straight line edge remaining perpendicular to a holder's elongate direction.

FIGS. 19,a,b,c are frontal views of multiple logos showing said indicia area's perimeter edge accommodating its advertising space without inhibiting any functioning of said indentational area(s), bending location(s), t tab, or t tab receiving aperture(s). Also shown are multiple depths of indicia logos which also do not inhibit functions of holder, and which are manufactured via injection molding.

### REFERENCE NUMERALS IN DRAWINGS

20—bottle-neck cap stop rim primary gripping aperture

21—straight line edge of primary aperture

24—aperture connecting slit

25—t tab receiving notch

26—t tab receiving aperture

28—perimeter indentation

30—aperture containment area

32—indicia display area

34—t tab

36—area surrounding primary aperture

38—directional elongate path of apertures

40—directional elongate path of holder

42—more rigid horizontal standoff area

44—springably expansive loop form

46—plastic bottle

48—plastic bottle cap

49—bottle cap's tamper proof retaining band

50—bottle's cap stop rim

51—gap between retaining band and cap stop rim

52—optional window suction cup

53—mounting stem of window suction cup

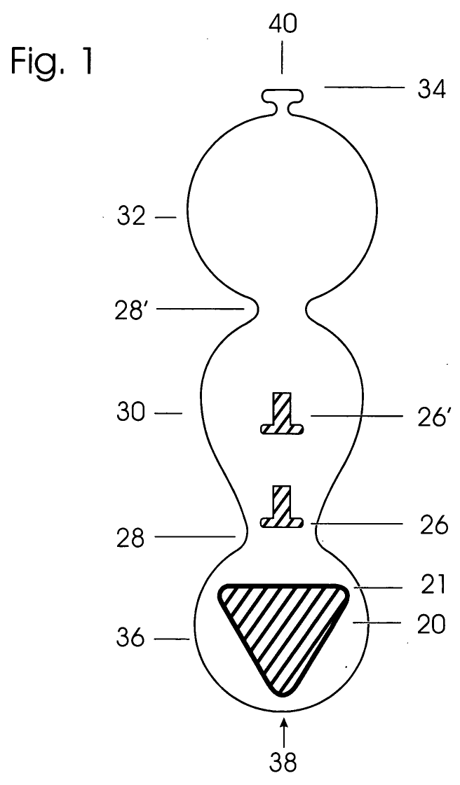

### FIG. 1—PREFERRED EMBODIMENT

A preferred embodiment of a conformingly pliable bottle display holder is illustrated in FIG. 1, where said holder's substrate is of a thin, generally planar and elongate pliable plastic material which can be repeatedly bent and straightened without fracturing, and having some degree of residual memory.

This preferred embodiment comprises three main areas which are an indicia display area 32, an oblong shaped aperture containment area 30, and an area surrounding a primary gripping aperture 36.

The largest area portion of this preferred embodiment, is a circular shaped indicia display area 32, where a t tab 34 in a shape of an alphabetical upper case letter t is centeredly located at one elongate end of said body, and is part of said indicia display area's 32 perimeter edge.

Said aperture containment area 30, contains two tab receiving apertures 26, which are each in the shape of an inverted alphabetical upper case letter t.

A first perimeter indentation area 28 of said holder's outer perimeter edge connects said oblong aperture containment area 30, with said area surrounding 36 a primary gripping aperture 20. A second perimeter indentation area 28′ of said holder's outer perimeter edge connects said oblong aperture containment area 30 to said indicia display area 32.

A primary gripping aperture 20 comprises 3 edges to surround a bottle's neck in an area located just vertically below a bottle's cap stop rim. A dimensional size of said aperture 20 is determined by a circumferencial dimension of a bottle's neck just vertically below said cap stop rim, for said 3 edged and triangular shaped aperture 20 to fit snugly tight. One straight line edge 21 of said 3 edges is perpendicular to an elongate directional path of said holder's body 40.

A remaining 2 edges of said triangular shape aperture are directionally diagonal to said body's elongate direction, where their apex points toward an elongate end of said body which is located oppositely from said t tab's location. All corners of where said 3 edges meet are marginally chamfered.

Said dimensional size of said aperture 20 will affect and determine a size of said area surrounding said aperture 36, wherein said area's 36 final size is negotiable between aesthetics and a function of providing enough material mass to support and retain said gripping aperture 20 to a bottle's cap stop rim.

Said indicia display area's 32 dimensional size is also negotiable between function and form; wherein it's size will determine said oblong area's 30 elongate length to achieve a proper engagement between said t tab 34 and said t tab receiving aperture 26 to form a springably expansive loop shape.

All said apertures and said t tab are in a generally elongate path 38, wherein said path parallels said elongate directional path of said body 40.

### OPERATION

A conformingly pliable bottle display holder as in FIG. 1 can be made of a generally planar and pliable polymer plastic material which can be repeatedly bent without fracturing. Low density polyethylene or LDPE is preferred, yet other materials work also, and including a standard milk jug's plastic material, or a sidewall of a plastic blow molded bottle. Thickness of material chosen can range from approximately 1/32 inch and up to ⅛ inch or more, and also determines which type of manufacturing process is chosen.

Apertures and outer perimeter shape may be completely cut through said substrate by hand with a cutting knife when a thinner substrate is chosen. A steel rule die may also be used to cut one unit at a time, or in multiples, and when an intermediate thickness of substrate is chosen. A machine press die set, or plastic mold injection processes may also be used for thicker or multi-depth holders.

Printing of an indicia display area 32, or engaging of a means of attachment for forming a looped shape 44 may be done by either a manufacturer or a consumer.

An area surrounding 36 a primary gripping aperture 20 is connectingly joined to an oblong shaped tab receiving aperture containment area 30 by a first indentation area 28 of a holder's outer perimeter edge. Said containment area 30 is connectingly joined to an indicia display area 32 by a second indentation area 28′ of said holder's outer perimeter edge. Both said first and said second indentation areas 28, 28′ weaken said holder's body to form predetermined bending locations. Said second indentation area 28′ is a bending location for forming a loop 44, wherein said indicia display area 32 and said aperture containment area 30 comprise said loop 44. Said first indentation area 28 aids to bendingly isolate said loop 44 from said area which surrounds 36 said primary gripping aperture 20. Both said bending locations aid to form said isolated loop 44.

Said primary aperture 20 within this preferred embodiment comprises 3 edges, and is located within said aperture surrounding area 36, and which is circular in shape, and located near one elongate end of said holder.

Of said 3 edges, one said straight line edge 21 is directionally perpendicular to an elongate directional path of said elongate holder 40. An apex corner of a remaining two edges is located nearer to said nearest one elongate end of said holder than said straight line edge's 21 location. All 3 corners of said 3 edged triangular shaped aperture 20 are marginally chamfered.

Said circular shaped indicia display area 32 contains a tab in a shape of an alphabetical letter t 34, and is part of said indicia display area's 32 outer perimeter edge, and is located at an opposite end of said holder's body from said primary aperture's 20 location. Said t tab 34 is centeredly positioned to said holder's width, and may be in a shape of an alphabetical upper or lower case letter t.

Said aperture containment area 30 contains at least one or more tab receiving aperture(s) 26 which acceptingly accommodate and retain said tab 34.

A perimeter edge of said indicia display area 32 may be in most any shape to accommodate indicia within, and is restricted only by said tab 34 location, and said bending location of said second indentation area 28′.

Said tab receiving aperture 26 may be formed in various shapes to receive said tab 34, and is restricted only in its size to retain said tab 34. Said tab receiving aperture 26 is located within said area 30, and invertedly positioned according to fsaid t tab 34, and near to said first perimeter indentation area 28.

Said engagement of said tab 34 and said aperture 26 produces said springably expansive loop shape 44, wherein a portion of said previously pliable material transforms into a more rigid and bottle retaining shape. A previously pliable material within an area at and near to said bending location of said second perimeter indentation area 28′ is especially more rigid within a formation of said looped shape 44. Said loop shape 44 prevents its own exiting from a user's pants pocket or clothing placket FIG. 11,44, as its springably expansive loop form tensioningly springs outwardly within said placements within a user's clothing.

Said holder's perimeter measurements are initially determined by a circumfrencial dimension of an area located just vertically below a bottle's cap stop rim 50, wherein said area determines a size of said aperture 20 to fit snugly tight. A sizing of said aperture 20 to achieve said tightness is accordingly affected by said substrate's thickness, pliability, and degree of residual memory. Said memory will retain a bottle with a light weight stress load as an entire said surrounding area 36 is located vertically below said bottle's cap stop rim 50.

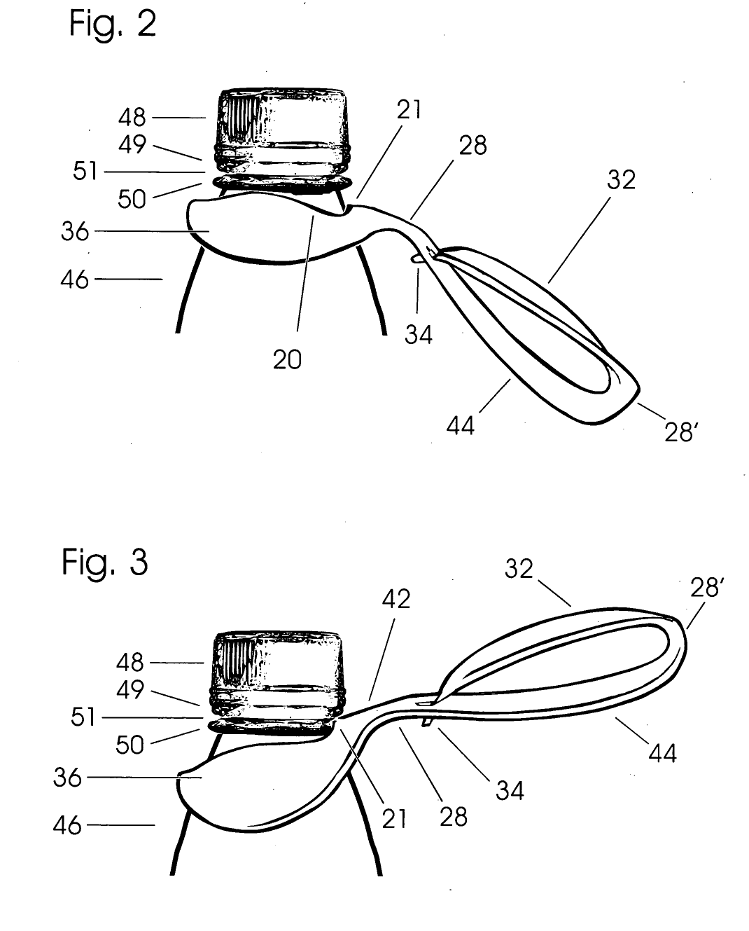

Said size of aperture 20 in turn affects a size of said surrounding area 36, where its volume of material retains sufficient gripping strength without excessive material surrounding a bottle's neck. Said indicia area 32 is generally circular in shape, and generally larger than said area 30. Said aperture containment area 30 is oblong in shape to accommodate a proper engagement of said tab and tab receiving aperture to form said loop shape FIG. 2, 44.

After an application of said primary aperture 20 to and surroundingly over a bottle's cap 48, tamper proof retaining band 49, and past said bottle's cap stop rim 50, and wherein said aperture 20 is located just vertically below said cap stop rim 50, a user may pull said looped area 44 vertically upward to achieve a tension-locked and wedged position of said straight line edge 21.

A user may hear and feel a snapping of said holder wherein said area surrounding 36 said triangular shaped aperture 20 begins to conformingly distort, as said straight line edge 21 advances vertically upward and surroundingly past said cap stop rim, wherein said edge 21 wedges in a gap 51 between a vertically lower edge of said tamper proof retaining band 49 and a vertically upper edge of said cap stop rim 50. Said aperture surrounding area 36 conformingly convexes around said bottles exterior surface located vertically below said cap stop rim 50, as portions of a remaining 2 of said 3 edges abut a vertically lower edge of said cap stop rim 50, and as portions of said remaining 2 edges encompassingly abut a sidewall edge of said rim 50.

A plurality of axially different curvatures and bends form and merge within one concentrated said area 36 surrounding said primary aperture 20. Said area 36 is in a wedge-locked multi-curvature form, and in a state of readinesss for additional weight stress loads of a user's activity. Said previously pliable material of said surrounding area 36 of said bottle display holder has transformed into a more rigid and bottle retaining form FIG. 3,36.

When in said locked multi-curvature position, and at a location near to where said area's 36 said convexing and conforming to a bottle's surface no longer touches said bottle's surface, said area 36 bends vertically upward for a short distance. Said area 36 then bends approximately horizontal and laterally from a locational point of contact at said straight line edge's 21 said wedged position. Said loop form 44 also extends laterally and is held in an approximate horizontal standoff position FIG. 3,42 from said bottle's cap, neck, and said bottle's vertical and upright position.

Said standoff position of said wedge-locked multi-curvature form is a portion of said area 36, where between a locational point of said straight line edge 21 and said first perimeter indentation area 28, said area between remains more rigid.

When in said horizontal standoff position 42, said loop shape 44 is held in a position which is bendingly isolated from said aperture surrounding area 36, and ready to bend vertically downward for insertion into a user's pocket FIG. 3.

Said straight line edge 21 is key to said wedge-locked multi-curvature position. If said straight line edge were an arcuate edge at a contact point of said wedging, said arcuate edge would more easily conform to a circumferencial shape of said retaining band's sidewall. Said more rigid standoff area 42 would collapse and overly conform to said bottle's cap 48, wherein said area 36 advances vertically upward and beyond said bottle cap's uppermost sidewall edge when subjected to an excessive activity of a user's jogging, running or jumping; and wherein said aperture 20 more easily disengages from said bottle 46.

Said wedged position of said straight line edge 21 retains said more rigid standoff area 42, and prevents any initial conforming to said retaining band's sidewall.

Said first indentation area 28 weakens said body's material strength to result in a predetermined bend location. Said more rigid standoff area 42 also retains said bend location's distance from a bottle's circumfrencial epicenter, and so facilitates a bottle to hang more vertically, whether from a users pocket, or other places of attachment FIG. 17. A bottle is shown in FIG. 16 which hangs askew to a surface when said wedged position is not engaged to form said more rigid standoff area 42.

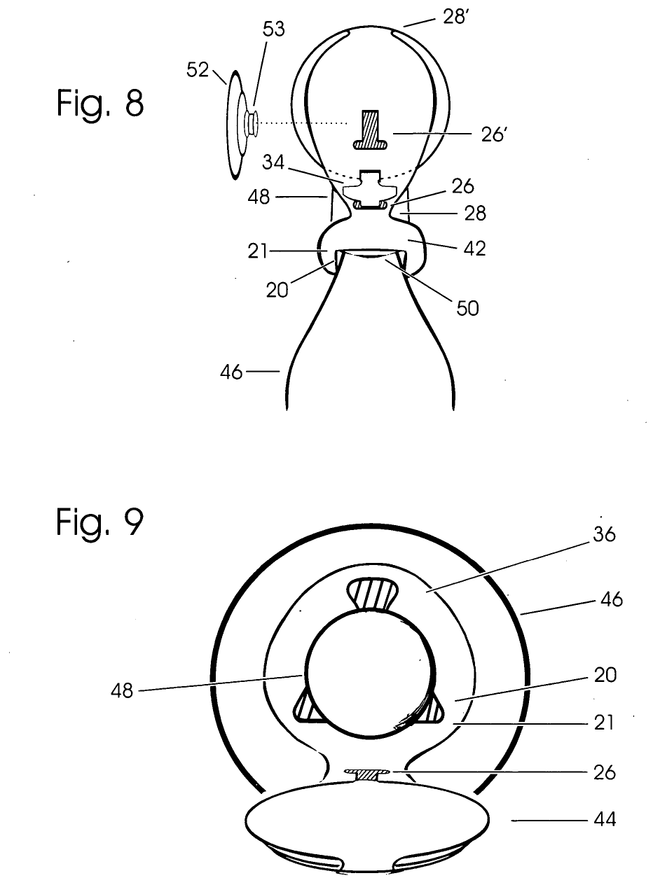

When a user chooses to display said holder with a same product to be held, a mounting stem 53 of a window suction cup 52 may be optionally placed within a second tab receiving aperture 26′ FIG. 8 within said aperture containment area 30 for hanging said holder and a held bottle against a glass surface display case FIG. 17.

A user who is reselling said bottle holders will find quick sales with said optional suction cup, as a holder may be offered for sale with or without said cup. When in a pocket held position, said cup further increases said loop shape's resistance to exiting said pocket. A same product which is to be held by a potential user's holder may hang from an interior glass surface of a refrigerated display case as said bottle display holder displayingly retains a ready to go, and cold bottle of soda or water.

Said bottle display holder will displayingly exhibit its bottle gripping ability as its exposed indicia bearing loop shape advertises anything said reseller needs to. Circular shape decals printed from a standard computer's printer will allow a user to quickly and easily advertise their sale price, business name, user's name or event.

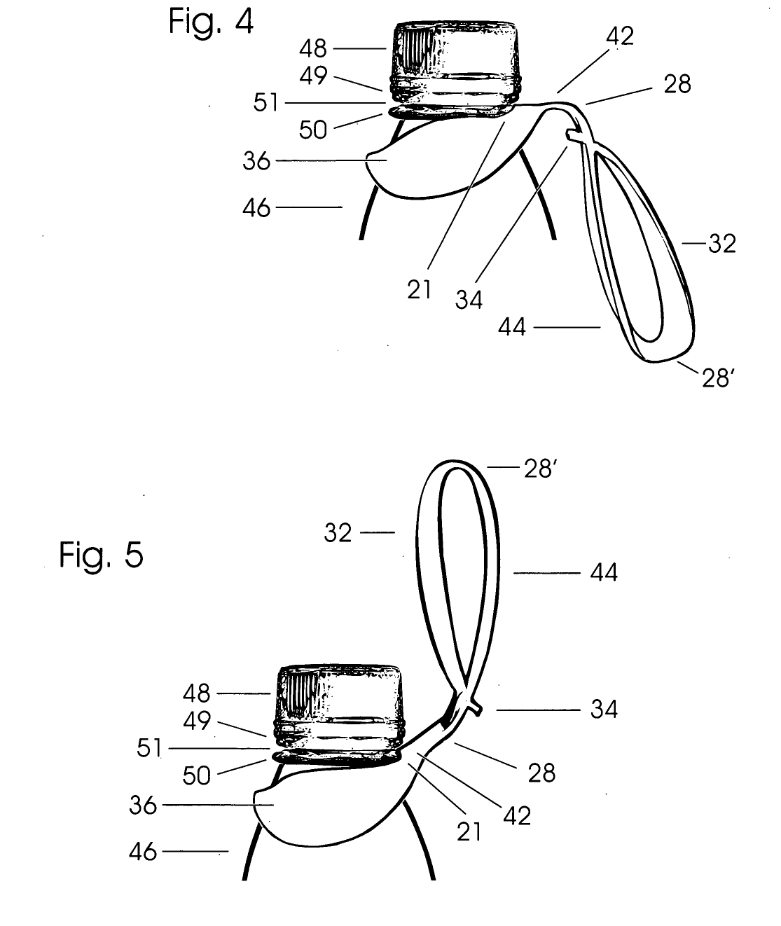

When using a holder in a casual walking mode, and when a user has no pants, belt, pockets, or closed loop object to attach said holder to, said loop form 44 may be inserted into a neck opening or placket of a user's shirt. The weight of a bottle's contents will pull vertically downward as said first indentation area 28 surrounds said opening's seam, wherein said springably expansive loop 44 will abut and slightly spring against said user's body. An approximately 90 degree bend located at said first indentation area's 28 bending location is a narrowed area of said holder's perimeter edge which bends over and around said seam of said user's clothing placket. Said perimeter edges near said bend location hang angled, and vertically downward and outward from said seam. Said angled edges contact said seam closely, and aid to inhibit further movement of said looped form 44 toward said seam and an exiting from said clothing placket. Said wedged position retains said bending location of said first indentation area 28 to be kept distanced from said bottle cap's sidewall FIG. 4,42, wherein said bottle hangs more vertically parallel to a user's body in said pocket held position.

On occasion where said gap 51 is dimensionally insufficient for a user to engage said wedged position, or when said gap 51 does not exist between said bottle cap's retaining band 49 and said bottle's cap stop rim 50, a user may first twist said bottle cap 48 until said tamper proof band 49 breaks its seal. Said band 49 will then freely shift vertically upward to provide a sufficient gap 51.

As said bottle cap 48 is re-tightened said straight line edge 21 is tightly pinched within its wedged position, wherein even more securement of said wedged position occurs, as when compared to most occasions where said gap does initially exist.

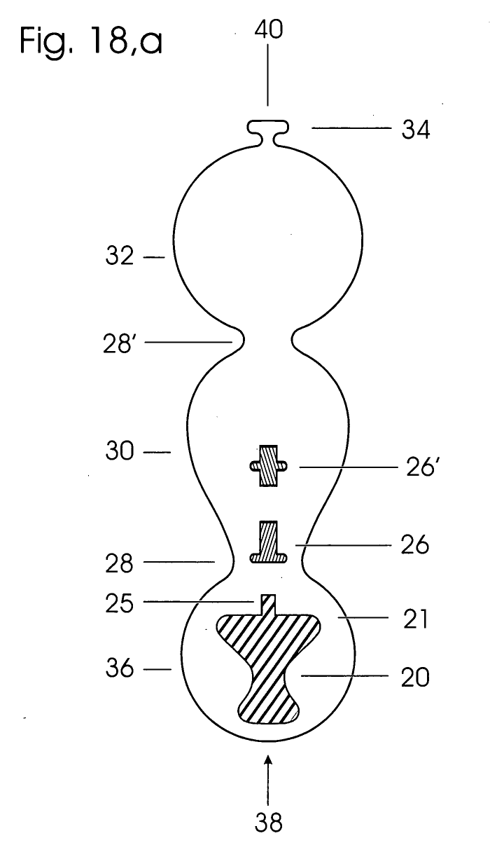

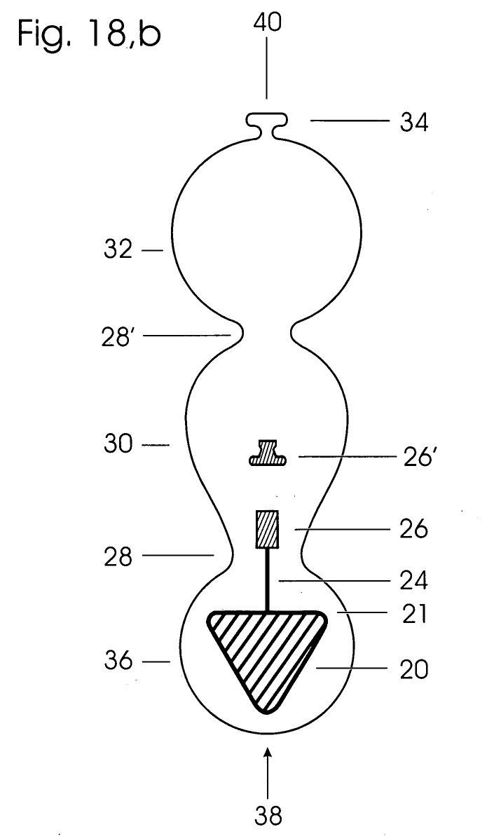

When a holder is made with more than one tab receiving aperture 20 within said tab containment area 30, or a tab receiving notch FIG. 18,a,25 within said primary aperture's perimeter, a user may choose to adjust said loop for a larger loop formation. Said tab receiving notch 25 is located further from said second indentation area's bending location 28′, and so tensioningly redirects said bending location in a direction further towards said notch. Placement of said tab within said notch produces a larger, yet more tensioned loop form which better retains said holder while in an open placket or shirt held position. In FIG. 18,a,b note several differently shaped tab receiving apertures and where all remain functional.

A means for attachment for forming said loop 44 may be a permanently fixed means such as a rivet or heat weld, wherein a user's pants belt may be threaded through said loop 44 for an indicia display bottle holding position from said belt.

Said means for attachment may also be a removably affixed means, including use of a riveted snap fastener, or said tab and tab receiving aperture means. Said removably affixed means allows a user to thread said indicia area behind and around said user's belt before fastening said loop, and without removing said belt.

Said optional suction cup is not necessary within said belt held position, yet will not interfere with any functioning of said bottle display holder's bottle retaining ability.

In between uses of said bottle display holder, a user may fold and compactingly store said holder in most any small space such as a back pants pocket, a compartment of a wallet, or in a flat and unfolded state within pages of a book.

### FIG. 2 THRU 17

Further details concerning drawings 2 through 17 include FIG. 2, where a holder is applied to a bottle and not yet placed in said wedged position. Said unwedged position of holder will retain light weight stress loads, and accordingly to said holder's substrate thickness and residual memory. Note the shape of said aperture surrounding area 36, and how said aperture's 20 shape is slightly distorted within its snugly tight fit as it surrounds a bottle's neck just vertically below said bottle's cap stop rim 50. A holder as positioned in FIG. 2 is easily packaged within a multiple and shrink wrapped pack.

A sizing of said triangular shaped aperture 20 is negotiable between ease of application or removal and a secure said wedged position. A manufacturer's targeted market will determine a final size of said aperture 20 according to said market's physical activities for a compromise between said ease of application and degree of said securement of said wedged position.

FIG. 3 shows said horizontal standoff area 42 after said wedged position is engaged. Note a gap 51 between a bottle cap's tamper proof retaining band 49 and said bottle's cap stop rim 50, and where said straight line edge 21 is wedged in said gap 51. Also note how said bending point of said first indentation area 28 is rigidly distanced from said bottle by said horizontal standoff area 42. Said wedged position assures a first bending at said first indentation area 28, and not any nearer to said bottle 46 or said bottle's cap 48.

A holder in FIG. 4 shows a position of said loop 44 as it is bent vertically downward and ready for insertion into a user's pants pocket. Notice said standoff area 42 and how it distances said bending location of said first indented area 28 from said bottle's neck.

A holder in FIG. 5 shows a wedged position of a holder as in FIG. 4, but with a different position of said loop 44 as it is bent vertically upward and ready for use in a pants belt attachment position, or as it would be used with an optional window suction cup 52 held position. Note said standoff area 42.

A holder in FIG. 5 shows a position of said loop 44 as it is bent vertically upward and ready for use in a pants belt attachment position, or as it would be used with an optional window suction cup 52 position. Note said standoff area 42.

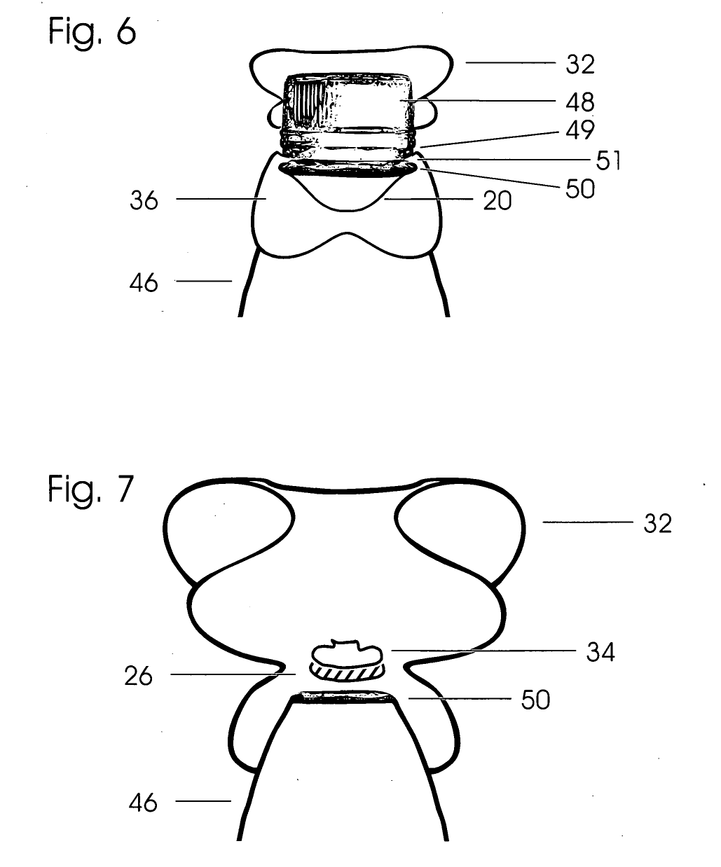

FIG. 6 and FIG. 7 show front and back views of holders fully mounted in said wedged positions. Two views of said indicia areas 32 change its apparent size, due to camera perspectives and distances from its lens. Other drawings supplied are also from a camera's j-peg files which are converted to vector line art, and are without distortional views. Note views and exposure of said cap stop rim 50.

FIG. 8 is a rear view of a fully mounted and wedged holder as if it were hanging from a glass surface of a display case. A second tab receiving aperture 26′ is shown with an optional window suction cup 52, and its mounting stem 53 before placement within said second aperture 26′. Note said wedgement of said edge 21.

FIG. 9 shows an overhead view of mounted holder as if it were hanging from a glass surface, and prior to it's said wedgement, where a slight distortion of said area 36 may be seen. This drawing is to better describe said snugly tightness of said aperture 20 as it surrounds a bottle's neck just vertically below it's cap stop rim.

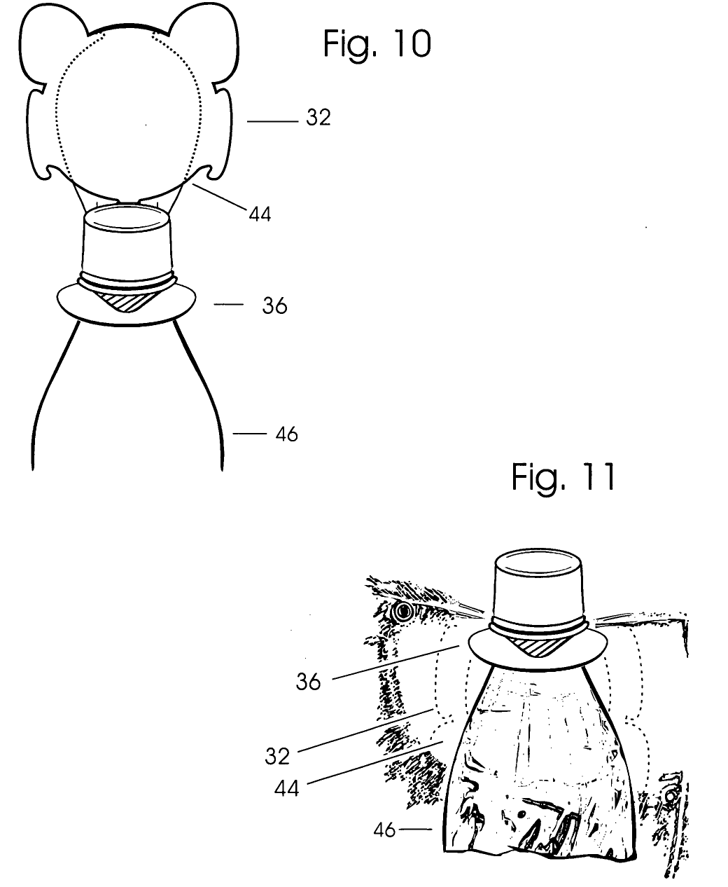

FIG. 10 shows a holder mounted to a bottle under a light weight stress load, and prior to any said wedging action. Said indicia area's 32 perimeter edge has been manufactured to compliment indicia art within. Said loop form 44 is positioned vertically upright and ready for said wedgement and its positioning to a user's belt.

FIG. 11 shows a similar bottle and holder as in FIG. 10, but with said loop 44 positioned within a user's pocket, where said indicia area 32 is hidden from view. Note how said aperture surrounding area 36 is not highly distorted in its un-wedged state. A holder's residual memory aids to retain a bottle in said pocket held position prior to said wedged position and under light weight loads and normal walking speeds.

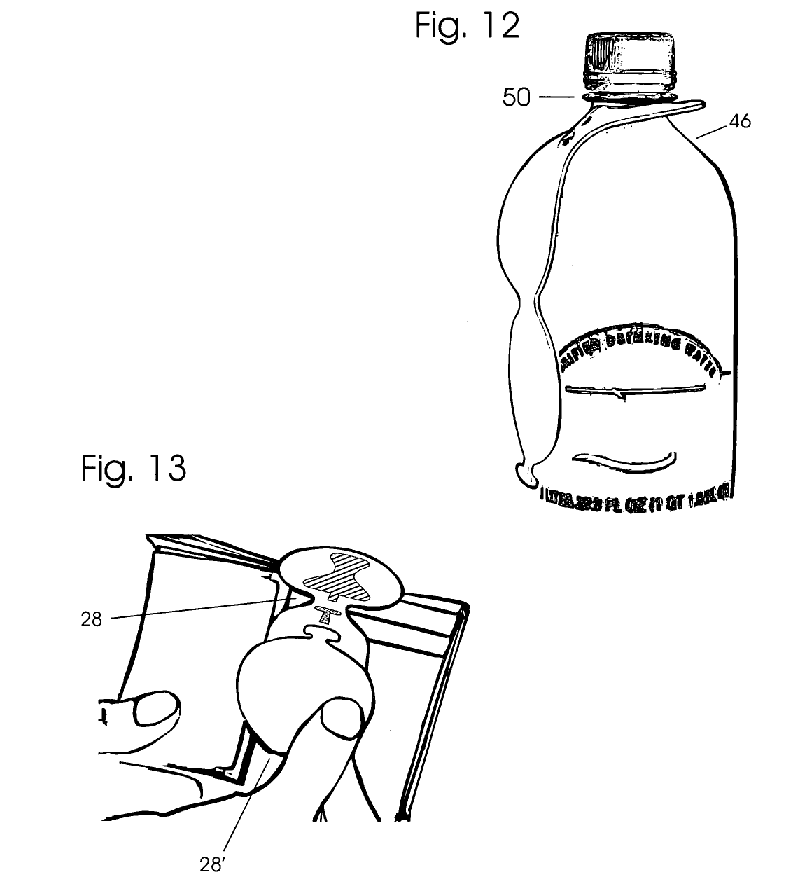

FIG. 12 shows a holder mounted to a bottle prior to engaging said loop 44, and prior to said wedging action. Note how a holder's body conforms to a bottle, and is ready for temporary attachment via shrink wrap or rubber banding, etc., and almost ready for machine vending or packaging within a multiple pack.

FIG. 13 shows an extreme example of conforming compactability, where a holder may be easily folded at locations of said indentation areas 28.

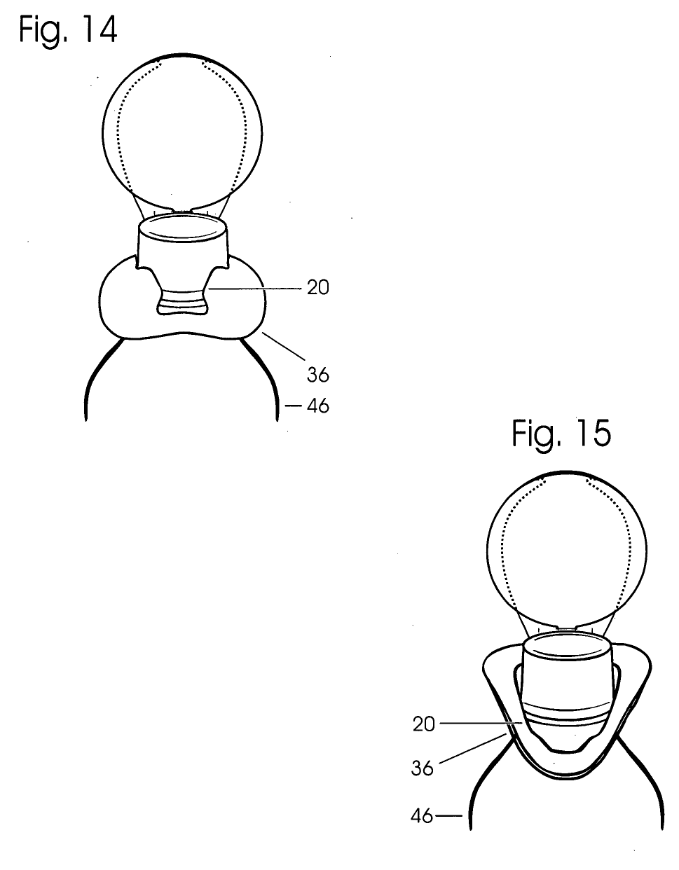

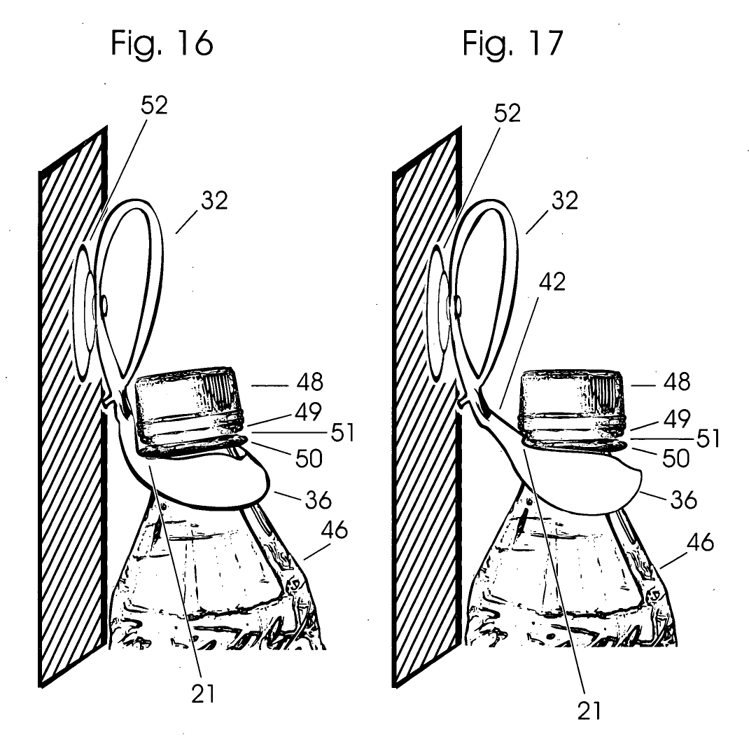

FIG. 14 shows how said aperture surrounding area 36 is distorted as it is being applied to a bottle.

FIG. 15 shows a different distortion of said area 36 upon removal. Any later described alternative embodiments of differently shaped primary apertures 20 are purposed to make said application and removal actions easier for a targeted market of users. Said differently shaped apertures 20 are to tweak said easier application and removal versus a secure gripping of said bottle's cap stop rim 50.

FIG. 16 shows a holder with said optional window suction cup 52 and a bottle hanging from a vertical glass surface as within a refrigerated glass showcase, with said aperture surrounding area 36 in an unwedged position. Said bottle is held askew to, and not vertically parallel with said glass surface. When a user opens a glass door of said showcase, said bottle is more positioned to swing outwards and away from said glass surface in said askewed and unwedged position. Said position also places more stress upon said suction cup 52, and is not aesthetic in appearance, as said bottle appears to be unstably held.

FIG. 17 shows a same comprisement as in FIG. 16, but after said wedging action of said straight line edge 21 is accomplished. Note how said horizontal standoff area 42 is angling slightly upward under it's heavy weight stress load, yet still retaining a more distanced space between said bottle's circumfrencial epicenter and said glass surface. Said bottle is more parallel with said glass surface, and is more stable in its position as it contacts said glass surface, and is less stressful upon said suction cup, and is more aesthetic in appearance of its held stability.

### FIG. 18,a,b THRU 19,a,b,c

FIG. 18,a,b, are alternative embodiments which concern said primary aperture 20 and it's particular shape to achieve a degree of easy application and removal of said holder by particular targeted markets.

In example, a holder designed for a child user would have a looser fitting of said aperture 20 over a bottle's said cap stop rim, wherein said child user could more easily apply and remove said holder.

In further example, a construction worker or outdoor sports enthusiast would need a holder which would more tightly grip a bottle in their different fields of physical activity, and would not be as concerned over ease of application and removal.

FIG. 18,a is a frontal view of an alternative embodiment showing a wineglass shaped aperture 20 with a notched area 25 for use as an alternative tab receiving aperture 26, and with said straight line edge 21 remaining perpendicular to said holder's elongate body 40. Note a second tab receiving aperture 26′, which enables a user to adjust said expansiveness of said loop 44.

Note the lower base area of said wineglass shaped aperture where some material of said aperture surrounding area 36 is removed, as compared to said gripping aperture of said preferred embodiment. Said lower base area permits said area 36 to increasingly conform to said bottle's exterior surface located below said cap stop rim 50, wherein degrees of said axially different curves and bends increase when said straight line edge 21 is subjected to said wedged position. Said area 36 is then further curved and further strengthened.

This embodiment which includes said notch 25 for use as a said tab receiving aperture 26 will allow adjustment for a larger and springier said loop form 44, for use under lighter weight stress loads held within a loose fitting clothing placket.

FIG. 18,b is a front view of an alternative embodiment showing said primary aperture 20 connected to a tab receiving aperture 26 via a slit 24, and with said straight line edge 21 remaining perpendicular to said holder's elongate direction 40. A specific length of said slit 24 which merges perpendicularly with said straight line edge 21 will predetermine said primary aperture's 20 degree of easy application or removal from a bottle for a specific targeted market, such as a child user who carries light weight stress loads. Note a second said tab receiving aperture 26′ for additional adjustment of said loop 44.

This embodiment shown within FIG. 18,b may be dependent on a removed and reapplied bottle cap's ability to compress said tamper proof retaining band against said straight edge line 21 against said rim 50 to achieve said wedged position. Said dependency on compression may also be determined by a holder's material thickness at a location at and near to said straight line edge 21.

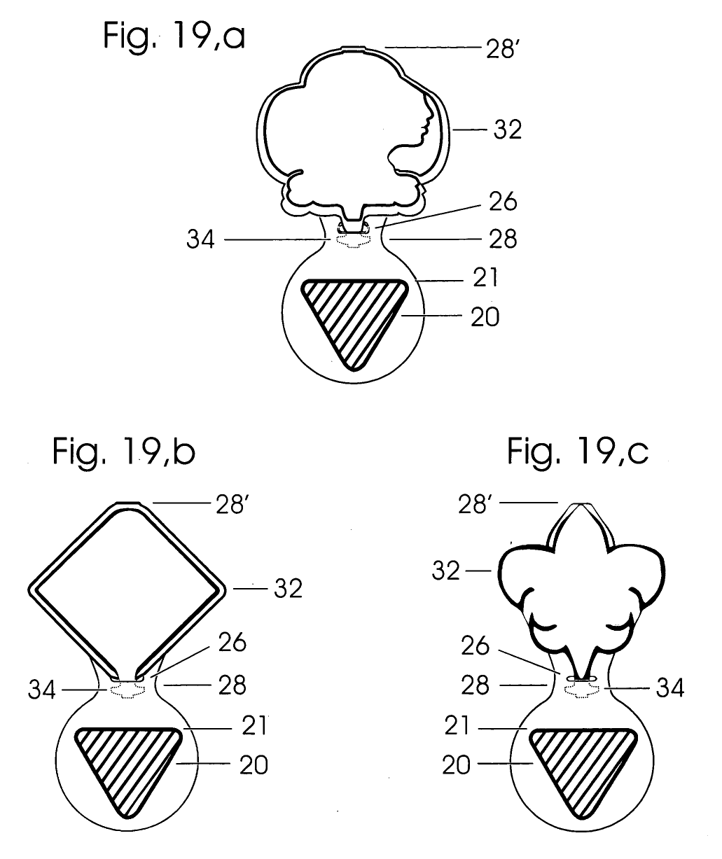

FIGS. 19,a,b,c show 3 differently shaped logos within special perimeter edge cuts. Note how two bending locations of perimeter indention areas 28 do not interfere with different forms shown within indicia display areas. Note how said tab 34 disappears within said tab receiving aperture 26 without obstructing a logos view.

Note interior lines of indicia, and that a dimensional depth of said lines may be produced via injection molded processes without interfering with any functioning of a holder's bending, folding, or bottle retention ability.

Logos are also shown to exemplify the multiple options a user will have to display their club, organization, or special event.

### CONCLUSION, RAMIFICATIONS, AND SCOPE

Color variations remain within the scope of this bottle display holder, and as naturally as a holder with a shape of q sun would be yellow, and as a shape of a moon might be blue. Specific colors may relate to specific indicia and or shapes, and are all inclusive within the scope of this particular bottle display holder.

Alternative embodiments not mentioned, such as a holder in a general perimeter shape of a water drop, bottle, elongate oval, round cornered rectangle, etc. are all within the scope of this particular holder's functioning and designability as partially and previously described concerning said indicia area's perimeter edge shaping.

In previous descriptions of said bottle display holder, said word display generally refers to said holder displaying its own indicia area as a bottle is being held to another object such as a user's pants belt via said loop, or a glass surface via said suction cup, and wherein said indicia display area 32 is within a potential user's view.

In previous descriptions of said holder's generally planar elongate body, said word generally may include dimensional depths of indicia within said indicia area 32 or anywhere within said holder's body, as when a holder is manufactured via said plastic injection mold processes.

In previous descriptions of said holder's pliable conformability transforming into a more rigid bottle retaining form, said word retaining generally describes an end result of comprisements cooperating to achieve a bottle's retention to another object. The immediate subject of said word retaining may concern retaining said holder to said bottle and or retaining said holder to another object.

Said comprisements such as an aperture's bottle cap stop rim gripping ability, or a more rigid standoff area within a wedged and more rigid aperture surrounding area, or an indentation area's bending location, or a springably expansive loop, or a tab and tab receiving aperture(s), or an optionally placed window suction cup are all cooperating comprisements. Each said comprisement better facilitates said result, and yet all are not needed to be present at a same time to achieve said result.

Accordingly, the reader will see that the scope of this new conformingly pliable bottle display holder goes beyond it's many advantages over previous holders;

This holder will not puncture skin or clothing; wherein new markets of consumers open up. This holder is one which will be safer in a young child's hands.

Other markets will include weapons-free areas such as school grounds, various institutions where many objects are prohibited as being potentially dangerous, public areas where metals are scanned, etc. The skier, snowboarder, surfer, mountain climber, skydiver, and numerous other intensely active sports enthusiasts will not be concerned with getting stabbed by this bottle holder.

This holder is pliably compactable to fit in a wallet's compartment, yet it's pliability opens up even more markets as it is more easily packaged and readied to be machine vendable with the same product it is intended to hold.

This holder with an optional window suction cup opens up new markets by selling itself as it displays itself holding an exact product it is going to carry; and at exactly the best point of purchase location possible; a refrigerated glass display case. It's own indicia display area opens up countless advertising methods for any user.

This holder has a safe one piece construction which contains the best market of all within it's simplicity; and that is it's simplicity. It is easy to make. And so, it is cheap to make; whether by simple diecutting, or machine stamping, or a more involved plastic injection mold process. This versatile bottle display holder is in itself a bottle holding display.

Although previous descriptions contain many specificities, these should not be construed as limiting the scope of the invention but as merely providing illustrations of some of the presently preferred embodiments of this invention.

Thank you for the chance to apply for this application for patent.

What we claim is:

1. A bottle holder for retaining a plastic bottle of a type wherein a bottle's cap breaks away from a tamper proof retaining band, and where said band is located just vertically above said bottle's cap stop rim, comprising;
(a) a generally planar, elongate and conformingly pliable plastic body;
(b) a surrounding area of an at least three edged primary gripping aperture;
(c) a means of attachment for forming a loop;
whereas said aperture is located near one elongate end of said elongate body;
wherein said aperture comprises at least 3 edges with at least one said edge being a straight line edge and directionally perpendicular to an elongate direction of said elongate body;
wherein corners where said at least 3 edges meet are marginally chamfered;
whereas and after said primary aperture's application to and past a bottle's cap, tamper proof retaining band, and cap stop rim, said aperture surrounding area snugly surrounds a bottle's neck just vertically below said cap stop rim;
wherein said aperture is predeterminedly sized for said straight line edge to be shifted vertically upward and vertically past said cap stop rim by a user's hand;
wherein said holder's material substrate located at and near to said straight line edge is sufficiently thin for said straight line edge to wedge within a gap located between a vertically lower edge of said retaining band and a vertically upper edge of said cap stop rim;
wherein portions of at least 2 of any remaining edges of said at least 3 edges remain vertically below said cap stop rim, and abut an underside edge of said cap stop rim;
wherein portions of said at least 2 of any remaining edges of said at least 3 edges partially encompass an exterior sidewall edge of said cap stop rim at a location near to each ending point of said straight line edge;
wherein and whilst said straight line edge is being engaged in said wedged position, said area surrounding said primary aperture conforms convexually to said bottle's exterior surface located vertically below said cap stop rim;
wherein a plurality of axially different curvatures and bends form and merge within said area surrounding said primary aperture;
wherein said surrounding area is in a more rigid and wedge-locked multi-curvature form, and in a state of readiness for additional weight stress loads of a user's activity;
wherein a previously pliable material of said surrounding area of said primary gripping aperture transforms into a more rigid bottle retaining form;
whereas said means of attachment for forming a loop describes a means to fasten an elongate end of said body which is located at an opposite end from said aperture's location, to a location between said ends;
wherein said means may be a permanently attached means;
and wherein said means may be a removably attached means;
wherein a portion of said conformingly pliable plastic body assumes a more rigid bottle retaining shape in a form of a springably expansive loop;
wherein said loop form aids to prevent said looped portion of said holder from exiting a user's pocket or clothing placket;
whereas said word retaining describes retaining said bottle to said holder and or retaining said holder to or within another object;
wherein said word retaining generally describes an end result of said holder retaining said bottle to said another object;
whereby said comprisements cooperate to function as a bottle retaining holder to achieve said end result as said holder's pliable conformability transforms into a more rigid bottle retaining form.

2. A holder as in claim 1, further including a holder;
whereby a heat welding serves as said means for a permanent means of attachment for forming a loop.

3. A holder as in claim 1, further including a holder;
whereby a rivet serves as said means for a permanent means of attachment for forming a loop.

4. A holder as in claim 1, further including a holder;
whereby a riveted snap fastener serves as said means for a removable means of attachment for forming a loop.

5. A holder as in claim 1, further including a holder;
whereby a tab and tab receiving aperture serves as said means for a removable means of attachment for forming a loop.

6. A holder as in claim 1, further including a holder;
whereas a tab in a shape of an alphabetical letter t is located at or near an opposite elongate end of said holder's body from said primary aperture's location;
whereas at least one or more aperture(s) is located between said ends of said elongate body and is predeterminedly sized to receive and retain said t tab;
whereby said t tab and said t tab receiving aperture(s) serves as said means for a removable means of attachment for forming a loop.

7. A holder as in claim 6, further including a holder;
whereas a portion of said holder's outer perimeter edge surrounds an area which surrounds said primary gripping aperture;
whereas a first indentation area of said holder's outer perimeter edge joins said primary aperture surrounding area to a tab receiving aperture containment area;
wherein said first indentation area weakens said holder's body to produce a predetermined bend location which bendingly isolates said primary aperture surrounding area from said tab receiving aperture containment area;
wherein at least one or more tab receiving aperture(s) are located within said tab receiving aperture containment area;
whereas a second indentation area of said holder's outer perimeter edge joins said tab receiving aperture containment area to an indicia display area;
wherein said second indentation area weakens said holder's body to produce a predetermined bend location for a formation of said loop form;
wherein said tab receiving aperture containment area and said second indentation area and said indicia area comprise said loop form;
whereas said tab remains at said opposite elongate end of said holder's body from said primary aperture's location, and is a part of said indicia area's perimeter edge;
whereas and after said tab is engaged with one said tab receiving aperture, a resulting said loop form is bendingly isolated from said primary aperture surrounding area;
whereby said indentation areas better aid to facilitate a precise means for a removable means of attachment for forming a loop which is bendingly isolated from said primary aperture surrounding area.

8. A holder as in claim 7, further including a holder;
whereas a notch is centeredly placed within said straight line edge and as a part of said primary gripping aperture's perimeter boundary;
wherein said notch extends said perimeter's boundary further outward and directionally towards a center area of said holder's body;
wherein one dimension of said notch is sufficiently sized to perform a function of said engagement of said wedging, and also receivingly accommodate and retain said t tab;
wherein said primary gripping aperture and said t tab serve as an alternative said means for a removable means of attachment for forming a loop;
whereby said loop form is adjustable to produce a larger sized said loop form.

9. A holder as in claim 7, further including a holder;
wherein said primary aperture remains near said one elongate end of said body;
whereas said primary aperture comprises a first 3 edged triangular shaped aperture which merges with a second and dimensionally smaller 3 edged triangular shaped aperture;
wherein a straight line edge of said first aperture remains directionally perpendicular to said elongate directional path of said elongate body;
wherein said second aperture is invertedly positioned according to said first aperture;
wherein said second aperture is located nearer to said one elongate end of said body than said first aperture's location;
wherein one apex corner of each said aperture is positioned to overlap another;
wherein said merging of both said first and said second apertures will form a shape similar to a frontal view of a top-heavy hour glass, or a wineglass shape;
wherein said straight line edge of said first aperture of said overlapping apertures may be described as a vertically upper rim area of said wineglass shape;
wherein a straight line edge of said second aperture is nearer to said nearest elongate end of body than said first aperture, and directionally parallels said straight line edge of said first aperture, and may be described as a vertically lower base area of said wineglass shape;
wherein all corners are marginally chamfered, and including locational areas where said first and said second aperture perimeters merge in said overlapping;
wherein said aperture area described as said lower base area of said wineglass shape replaces material of said body which would restrict further conforming of said surrounding area to said bottle's surface located vertically below said cap stop rim when in said wedged position;
wherein conformability is further advanced in said aperture surrounding area by removing said material in said described lower base area, resulting in increased axial degrees of said axially different curvatures and bends;
whereby said merged aperture's surrounding area is further strengthened.

10. A holder as in claim 7, further including a holder;
wherein said primary gripping aperture remains near said one elongate end of said body;
whereas said primary gripping aperture comprises at least one said edge which merges with at least one or more element(s) of; one or more slit(s) and or one or more notch(es) and or one or more said tab receiving aperture(s);
wherein said primary aperture is dimensionally elongated and or lengthened in a direction which parallels said elongate direction of said elongate body;
wherein a specific length of said slit determines a degree of easy application and or removal from said bottle's cap, retaining band, and cap stop rim;
wherein a specific length of said slit determines a degree of easy disengagement of said aperture surrounding area from its multi-curved and wedged position;
wherein said primary aperture assumes a more easily appliable and removable shape upon said primary aperture's application or its removal from said bottle's cap, retaining band, and cap stop rim;
wherein and after said application or said removal, a residual memory of said body returns said more easily appliable shape to or near to it's original shape;
wherein and after said engagement of said wedging, said aperture surrounding area is more easily disengaged from said wedged position by a user's hand;
whereby a child user may more easily disengage said wedge-locked multi-curvature shape of said area surrounding said primary gripping aperture.

11. A holder as in claim 7, further including a holder;
whereas at least two said tab receiving apertures are located within said tab receiving aperture containment area;
wherein a window suction cup's mounting stem is positioned within one of said tab receiving apertures;
wherein and when said looped form is positioned within a user's pocket, said cup abuts an area just vertically below a seam of said pocket's opening;
wherein said cup further increases said holder's resistance to its exiting from said user's pocket;
whereby said cup facilitates said holder to be a more bottle retaining form.

12. A holder as in claim 7, further including a holder;
whereas at least two said tab receiving apertures are located within said tab receiving aperture containment area;
wherein a window suction cup's mounting stem is positioned within one of said tab receiving apertures;
whereas and after said holder's said primary gripping aperture is fully applied past said bottle's cap stop rim, and after said wedge-locked multi-curvature form is engaged;
wherein a portion of said aperture surrounding area is located between said straight line edge and said first perimeter indentation area;
wherein said portion of said aperture surrounding area remains rigid;
wherein said bending location of said first indentation area is laterally distanced from said bottle cap's sidewall and circumfrencial epicenter;
whereas and when said bottle holder and held bottle are attached to a vertically upright positioned smooth glass surface using said suction cup;
wherein said rigid portion of said aperture surrounding area retains said bend location's distance from said bottle cap's sidewall and circumfrencial epicenter;
whereby said bottle's vertical uprightness is held in a more vertically paralleling position with said glass surface.

13. A holder as in claim 12, further including a holder;
whereas said suction cup of said wedge positioned holder retains a held bottle against an interior glass surfaced door of a refrigerated display case;
wherein said held bottle is held physically closer to an approaching potential user than most other products within said display case;
wherein said held bottle is more likely to be a first seen bottle as a user opens said door for a final purchasing decision;
whereas said indicia display area of said holder is receptive to a pricing or identifying or advertising indicia marking applied by either a manufacturer or a merchandising user;
whereby said holder serves as a bottle display holder at a prime location of said purchasing decision within said merchandising user's outlet.

14. A holder as in claim 7, further including a holder;
whereas a portion of said springably expansive loop shaped form comprises said indicia display area;
wherein and at a time of being manufactured, said indicia display area may be altered in direction and or shape and or depth in any area excluding immediate locations of said second indentation area and said t tab;
whereby said indicia area is somewhat alterable in its form at a time of manufacturing to correspond with various indicia within said indicia area without inhibiting any functioning of said holder.

15. A holder as in claim 14, further including a holder;
whereas said indicia display area may be manufactured in various shapes or logo designs;
wherein specific colors may be needed to correspond with said shapes and or logo designs;
whereby said colors are all inclusively within the scope of said holder.

16. A holder as in claim 7, further including a holder;
whereas said holder is pre-mounted to a bottle with no engagement of said means for a removable means of attachment for forming a loop;
wherein said wedged position is not engaged;
wherein said aperture containment area and said indicia area hang vertically downward from said bottle's cap stop rim area, and adjacent to a bottle's sidewall;
wherein said tabulated end of said holder is ready to be temporarily affixed to said sidewall via shrink wrap, rubber bandings, or like materials;
whereby said holder is machine vendable with a product it holds.

17. A holder as in claim 7, further including a holder;
whereas said indicia display area within said loop form is engageable and disengageable to a user's pants belt or other closed loop objects via said means for a removable means of attachment for forming a loop;
whereby said display area is an engageably portable display medium.

18. A holder as in claim 7, further including a holder;
whereas said holder is pre-mounted to a bottle after engagement of said means for a removable means of attachment for forming a loop;
wherein prior to or after said engagement of said wedge-locked position, said indicia area stands approximately horizontal to a bottle's vertical and upright position, and approximately below said bottle's vertical height;
whereby said holder is easily packagable within a shrink wrapped multi-pack of bottles.

19. A holder as in claim 7, further including a holder;
whereas said loop form is engageable via said tab and aperture means;
wherein a user may thread said indicia area through a pants belt or closed loop object prior to said engagement of said means;
whereby said belt remains fasteningly intact as said holder is attached thereto.

20. A holder as in claim 7, further including a holder;
whereas and when said straight line edge is maneuvered by an end user or final purchaser to engage said wedged position;
wherein and when said gap is dimensionally insufficient to accommodate a thickness of said straight line edge for said engagement of said wedged position;
and wherein and when said gap does not initially exist between said tamper proof retaining band and said bottle's cap stop rim;
whereas said bottle's cap is unscrewed to break a seal of said tamper proof retaining band;
wherein said band shifts vertically upward to provide a dimensionally sufficient said gap;
wherein said straight line edge wedges between a vertically lower edge of said upwardly shifted tamper proof retaining band and a vertically upper edge of said bottle's cap stop rim;
whereas and when said cap is re-tightened, said band is forced vertically downward to abut said straight line edge;
wherein said straight line edge is tightly pinched between said band and said bottle's cap stop rim;
whereby even more securement of said straight line edge within said wedged position is produced when said gap is initially dimensionally insufficient.
